(19) United States
(12) Patent Application Publication
(10) Pub. No.: US 2021/0223441 A1
(43) Pub. Date: Jul. 22, 2021

(54) MICRO-LENS STRUCTURE AND MANUFACTURING METHOD THEREFOR

(71) Applicant: Powerchip Semiconductor Manufacturing Corporation, Hsinchu (TW)

(72) Inventors: Chun-Liang Chen, Hsinchu County (TW); Ya-Ting Chen, Hsinchu County (TW); Shih-Ping Lee, Hsinchu City (TW)

(73) Assignee: Powerchip Semiconductor Manufacturing Corporation, Hsinchu (TW)

(21) Appl. No.: 16/813,757

(22) Filed: Mar. 10, 2020

(30) Foreign Application Priority Data
Jan. 22, 2020 (TW) 109102518

(51) Int. Cl. G02B 3/00

(52) U.S. Cl. CPC G02B 3/0043; G02B 3/0025

(57) ABSTRACT

A micro-lens structure includes a substrate and a micro-lens. The micro-lens includes a shape adjustment portion and a lens pattern. The shape adjustment portion includes a plurality of shape adjustment patterns on the substrate. The lens pattern covers the shape adjustment patterns.

### CROSS-REFERENCE TO RELATED APPLICATION

This application claims the priority benefit of Taiwan application serial no. 109102518, filed on Jan. 22, 2020. The entirety of the above-mentioned patent application is hereby incorporated by reference herein and made a part of this specification.

### BACKGROUND

### Technical Field

The disclosure relates to a semiconductor device and a manufacturing method therefor, and more particularly, to a micro-lens structure and a manufacturing method therefor.

### Description of Related Art

At present, micro-lenses have been commonly used in optical devices (such as image sensors or displays) to improve the performance of optical devices. However, due to limitations to materials and manufacturing processes, it is difficult to form micro-lenses with large heights.

### SUMMARY

The disclosure provides a micro-lens structure and a manufacturing method therefor, whereby a micro-lens with a large height may be formed.

In an embodiment of the disclosure, a micro-lens structure including a substrate and a micro-lens is provided. The micro-lens includes a shape adjustment portion and a lens pattern. The shape adjustment portion includes a plurality of shape adjustment patterns on the substrate. The lens pattern covers the shape adjustment patterns.

According to an embodiment of the disclosure, in the micro-lens structure, the shape adjustment patterns may have various intervals.

According to an embodiment of the disclosure, in the micro-lens structure, the shape adjustment portion may have a dense pattern region and an isolated pattern region. Intervals of the shape adjustment patterns in the dense pattern region may be smaller than intervals of the shape adjustment patterns in the isolated pattern region.

According to an embodiment of the disclosure, in the micro-lens structure, a height of the lens pattern in the dense pattern region may be greater than a height of the lens pattern in the isolated pattern region.

According to an embodiment of the disclosure, in the micro-lens structure, the shape adjustment patterns and the lens pattern may have an identical refractive index.

According to an embodiment of the disclosure, in the micro-lens structure, the shape adjustment patterns and the lens pattern may have different refractive indices.

According to an embodiment of the disclosure, in the micro-lens structure, the shape adjustment patterns and the lens pattern may be made of an identical material.

According to an embodiment of the disclosure, in the micro-lens structure, the shape adjustment patterns and the lens pattern may be made of different materials.

According to an embodiment of the disclosure, in the micro-lens structure, a material of the shape adjustment patterns is, for instance, a positive photoresist material or a negative photoresist material.

According to an embodiment of the disclosure, in the micro-lens structure, a material of the lens pattern is, for instance, a positive photoresist material or a negative photoresist material.

According to an embodiment of the disclosure, in the micro-lens structure, the micro-lens may be of a symmetrical shape.

According to an embodiment of the disclosure, in the micro-lens structure, the micro-lens may be of an asymmetrical shape.

In an embodiment of the disclosure, a method for manufacturing a micro-lens structure is provided, and the method includes following steps. A shape adjustment portion is formed on a substrate, and the shape adjustment portion includes a plurality of shape adjustment patterns. A lens pattern covering the shape adjustment patterns is formed.

According to an embodiment of the disclosure, in the method for manufacturing the micro-lens structure, a method for forming the shape adjustment patterns may include following steps. A photoresist material layer is formed on the substrate. An exposure process is performed on the photoresist material layer. After the exposure process is performed on the photoresist material layer, a development process is performed on the photoresist material layer.

According to an embodiment of the disclosure, the method for manufacturing the micro-lens structure may further include performing curing treatment on the shape adjustment patterns.

According to an embodiment of the disclosure, in the method for manufacturing the micro-lens structure, a method for forming the lens pattern may include following steps. A photoresist material layer covering the shape adjustment patterns is formed. An exposure process is performed on the photoresist material layer. After the exposure process is performed on the photoresist material layer, a development process is performed on the photoresist material layer.

According to an embodiment of the disclosure, the method for manufacturing the micro-lens structure may further include performing curing treatment on the lens pattern.

According to an embodiment of the disclosure, the method for manufacturing the micro-lens structure may further include following steps. Before the shape adjustment portion is formed, a light transmission layer is formed on the substrate. The shape adjustment patterns and the lens pattern are located on the light transmission layer. The light transmission layer is patterned with use of the shape adjustment patterns and the lens pattern as a mask, and a pattern composed of the shape adjustment patterns and the lens pattern is transferred to the light transmission layer.

According to an embodiment of the disclosure, in the method for manufacturing the micro-lens structure, a material of the light transmission layer is, for instance, silicon oxide, silicon nitride, silicon oxynitride, metal oxide, or an organic light transmission material.

According to an embodiment of the disclosure, in the method for manufacturing the micro-lens structure, the shape adjustment patterns and the lens pattern as the mask may be gradually consumed and removed during the patterning process.

In view of the foregoing, in the micro-lens structure and the manufacturing method therefor as provided in one or more embodiments of the disclosure, the lens pattern covers the shape adjustment patterns; accordingly, the shape and the height of the lens pattern may be adjusted by arranging the shape adjustment patterns, whereby the micro-lens with a large height may be formed.

In order to make the aforementioned and other features and advantages provided in the disclosure invention comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments provided in the disclosure and, together with the description, serve to explain the inventive principles.

FIG. 1A to FIG. 1D are cross-sectional views of a manufacturing process for a micro-lens structure according to an embodiment of the disclosure.

FIG. 2 is a cross-sectional view of a micro-lens structure according to another embodiment of the disclosure.

FIG. 3A to FIG. 3B are cross-sectional views of a manufacturing process for a micro-lens structure according to another embodiment of the disclosure.

### DETAILED DESCRIPTION OF DISCLOSED EMBODIMENTS

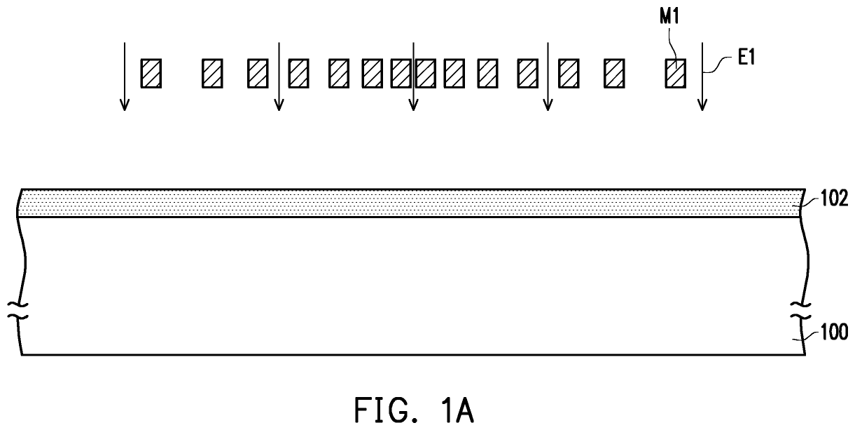

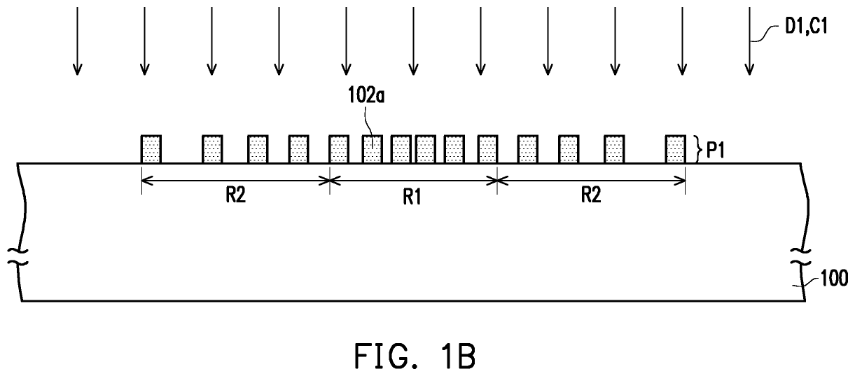

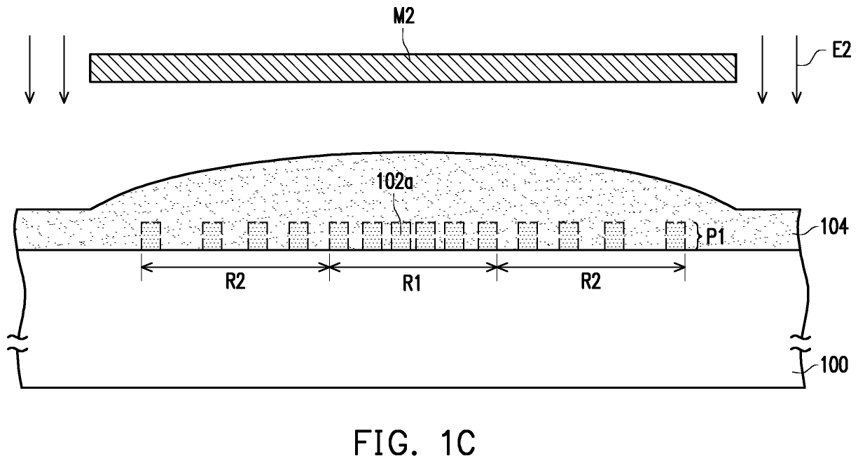

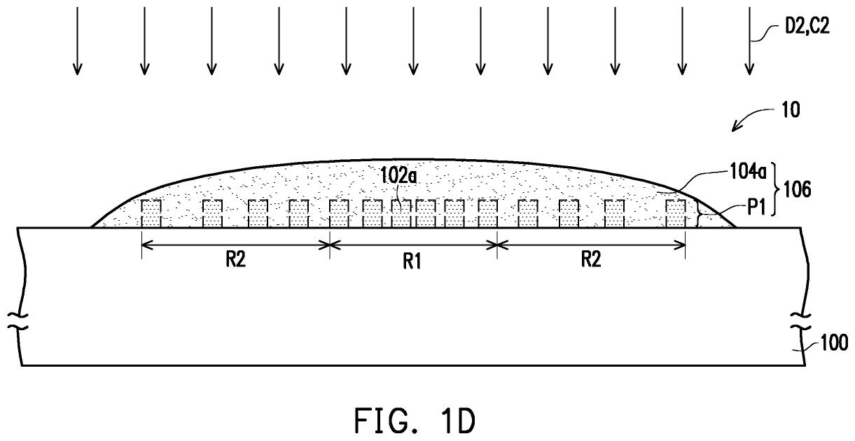

FIG. 1A to FIG. 1D are cross-sectional views of a manufacturing process for a micro-lens structure according to an embodiment of the disclosure.

With reference to FIG. 1A, a photoresist material layer 102 is formed on a substrate 100. In addition, various required semiconductor devices (not shown) may be formed on the substrate 100 according to product requirements. For instance, the semiconductor devices may include a photosensitive device (e.g. a photodiode), a pixel, a transistor, a color filter layer, a metal interconnect, or a combination thereof. The photoresist material layer 102 is, for instance, made of a positive photoresist material or a negative photoresist material. In this embodiment, the material of the photoresist material layer 102 is the positive photoresist material, but the disclosure is not limited thereto. A method for forming the photoresist material layer 102 is, for instance, a spin coating method.

Next, an exposure process E1 is performed on the photoresist material layer 102. For instance, the exposure process E1 may be performed on the photoresist material layer 102 with use of a photomask M1 as a mask.

With reference to FIG. 1B, after the exposure process E1 is performed on the photoresist material layer 102, a development process D1 is performed on the photoresist material layer 102, whereby a portion of the photoresist material layer 102 may be removed, and a shape adjustment portion P1 may be formed on the substrate 100. The shape adjustment portion P1 includes a plurality of shape adjustment patterns 102a. The shape adjustment patterns 102a may have various intervals. The shape adjustment portion P1 may have a dense pattern region R1 and an isolated pattern region R2. The intervals of the shape adjustment patterns 102a in the dense pattern region R1 may be smaller than the intervals of the shape adjustment patterns 102a in the isolated pattern region R2. For instance, the average interval of the shape adjustment patterns 102a in the dense pattern region R1 may be smaller than the average interval of the shape adjustment patterns 102a in the isolated pattern region R2, but the disclosure is not limited thereto. In this embodiment, the shape adjustment patterns 102a exemplarily have the same size (e.g., the same width), but the disclosure is not limited thereto. In other embodiments, the shape adjustment patterns 102a may have different sizes. In addition, since the shape adjustment patterns 102a are formed by the photoresist material layer 102, the shape adjustment patterns 102a and the photoresist material layer 102 may have the same material. The material of the shape adjustment patterns 102a is, for instance, a positive photoresist material or a negative photoresist material. In this embodiment, the shape adjustment patterns 102a are made of the positive photoresist material, but the disclosure is not limited thereto.

Curing treatment C1 may then be performed on the shape adjustment patterns 102a. The curing treatment C1 is, for instance, thermal curing treatment or light curing treatment. In other embodiments, the curing treatment C1 performed on the shape adjustment patterns 102a may be omitted.

In this embodiment, although the method for forming the shape adjustment patterns 102a is performed in the manner described above, for instance, the disclosure is not limited thereto. In other embodiments, the shape adjustment patterns 102a may be formed by the negative photoresist material. Besides, a photolithography process adopting negative photoresist is a semiconductor process technology known to people having ordinary knowledge in the pertinent field, which will not be described hereinafter.

With reference to FIG. 1C, a photoresist material layer 104 covering the shape adjustment patterns 102a is formed. A material of the photoresist material layer 104 is, for instance, a positive photoresist material or a negative photoresist material. In this embodiment, the photoresist material layer 104 is made of the positive photoresist material, but the disclosure is not limited thereto. A method for forming the photoresist material layer 104 is, for instance, a spin coating method.

Next, an exposure process E2 is performed on the photoresist material layer 104. For instance, the exposure process E2 may be performed on the photoresist material layer 104 with use of a photomask M2 as a mask.

With reference to FIG. 1D, after the exposure process E2 is performed on the photoresist material layer 104, a development process D2 is performed on the photoresist material layer 104. As such, a portion of the photoresist material layer 104 may be removed to form a lens pattern 104a covering the shape adjustment patterns 102a. Since the lens pattern 104a covers the shape adjustment patterns 102a, the shape and the height of the lens pattern 104a may be adjusted by arranging the shape adjustment patterns 102a, whereby the micro-lens 106 with a large height may be formed. For instance, since the density of the shape adjustment patterns 102a in the dense pattern region R1 is higher than the density of shape adjustment patterns 102a in the isolated pattern region R2, the height of the lens pattern 104a in the dense pattern region R1 may be higher than the height of the lens pattern 104a in the isolated pattern region R2. In addition, since the lens pattern 104a is formed by the photoresist material layer 104, the lens pattern 104a and the photoresist material layer 104 may have the same material. The material of the lens pattern 104a is, for instance, a positive photoresist material or a negative photoresist material. In this embodiment, the lens pattern 104a is made of the positive photoresist material, but the disclosure is not limited thereto.

Curing treatment C2 may then be performed on the lens pattern 104a. The curing treatment C2 is, for instance, thermal curing treatment or light curing treatment. In other embodiments, when the curing treatment C1 performed on the shape adjustment patterns 102a is omitted, the shape adjustment patterns 102a and the lens pattern 104a may be cured simultaneously through performing the curing treatment C2.

In some embodiments, given that a plurality of micro-lenses 106 are formed by performing the aforesaid method, the adjacent micro-lenses 106 may be separated or merged by adjusting exposure conditions.

In this embodiment, although the method for forming the lens pattern 104a is exemplified by the above method, the disclosure is not limited thereto. In other embodiments, the lens pattern 104a may be formed by the negative photoresist material. Besides, a photolithography process adopting negative photoresist is a semiconductor process technology known to people having ordinary knowledge in the pertinent field, which will not be described hereinafter.

The micro-lens structure 10 provided in this embodiment will be described with reference to FIG. 1D. In addition, although the method for forming the micro-lens structure 10 is exemplified by the above method, the disclosure is not limited thereto.

With reference to FIG. 1D, the micro-lens structure 10 includes the substrate 100 and the micro-lens 106. In this embodiment, one micro-lens 106 may correspond to one photosensitive device (not shown) in an image sensor or one pixel (not shown) in a display. The micro-lens 106 includes the shape adjustment portion P1 and the lens pattern 104a. The shape adjustment portion P1 includes the shape adjustment patterns 102a on the substrate 100. The lens pattern 104a covers the shape adjustment patterns 102a. The shape adjustment patterns 102a and the lens pattern 104a may have the same refractive index or different refractive indices. Provided that the shape adjustment patterns 102a and the lens pattern 104a have the same refractive index, the refractive index of the micro-lens 106 may be uniform. In addition, the shape adjustment patterns 102a and the lens pattern 104a may be made of the same material or different materials.

In addition, the micro-lens 106 may be of a symmetrical shape or an asymmetrical shape. In this embodiment, the micro-lens 106 is of the symmetrical shape, for instance, but the disclosure is not limited thereto. For instance, the shape adjustment patterns 102a are arranged on the substrate 100 in a symmetrical manner, and the intervals of the shape adjustment patterns 102a are designed to gradually increase from the center to both sides, whereby the distribution of the shape adjustment patterns 102a may become less dense from the center to the two sides. As a result, the micro-lens 106 may have the symmetrical shape with the height gradually decreasing from the center to both sides, and the highest point of the micro-lens 106 may be located at the center of the shape adjustment portion P1.

Since the material, the configuration manner, the manufacturing method, and the effects of each component in the micro-lens structure 10 have been described in detail in the above embodiments, no further description will be provided hereinafter.

Based on the above embodiments, it can be known that in the micro-lens structure 10 and the manufacturing method therefor, the lens pattern 104a covers the shape adjustment patterns 102a. Accordingly, the shape and the height of the lens pattern 104a may be adjusted by arranging the shape adjustment patterns 102a, whereby the micro-lens 106 with a large height may be formed.

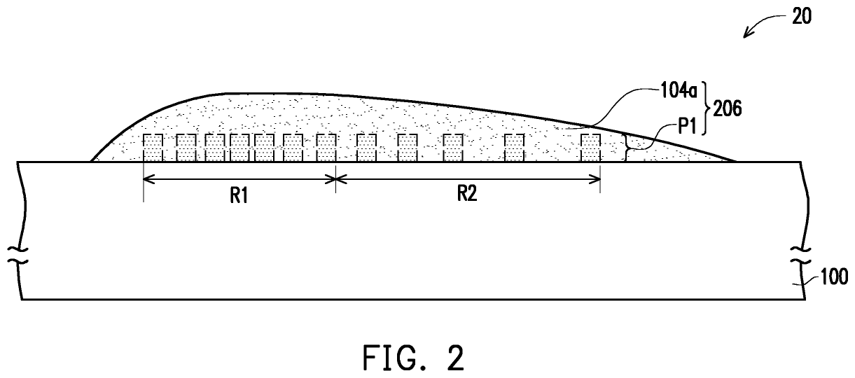

FIG. 2 is a cross-sectional view of a micro-lens structure according to another embodiment of the disclosure.

With reference to FIG. 1D and FIG. 2, the difference between a micro-lens structure 20 depicted in FIG. 2 and the micro-lens structure 10 depicted in FIG. 1D is described below. In the micro-lens structure 20, the micro-lens 206 may be of an asymmetrical shape. For instance, by arranging the shape adjustment patterns 102a on the substrate 100 in an asymmetrical manner, the density of the shape adjustment patterns 102a adjacent to one end of the shape adjustment portion P1 is greater than the density of the shape adjustment patterns 102a adjacent to the other end of the shape adjustment portion P1; thereby, the micro-lens 206 may be of the asymmetrical shape, and the highest point of the micro-lens 206 may be offset from the center of the shape adjustment portion P1 and adjacent to one end of the shape adjustment portion P1. In addition, since the shape of the micro-lens 106 depicted in FIG. 1D and the shape of the micro-lens 206 depicted in FIG. 2 are different, the micro-lens 106 and the micro-lens 206 may have different focal positions and curvature radii.

Accordingly, the shape adjustment patterns 102a may be applied to adjust the shape and the height of the lens pattern 104a, so as to form the micro-lens 106 and the micro-lens 206 with the large height. Moreover, the shape adjustment patterns 102a may also be applied to adjust the focal positions and curvature radii of the micro-lens 106 and the micro-lens 206. Note that the same components in FIG. 1D and FIG. 2 are denoted by the same reference numbers and thus will not be further described hereinafter.

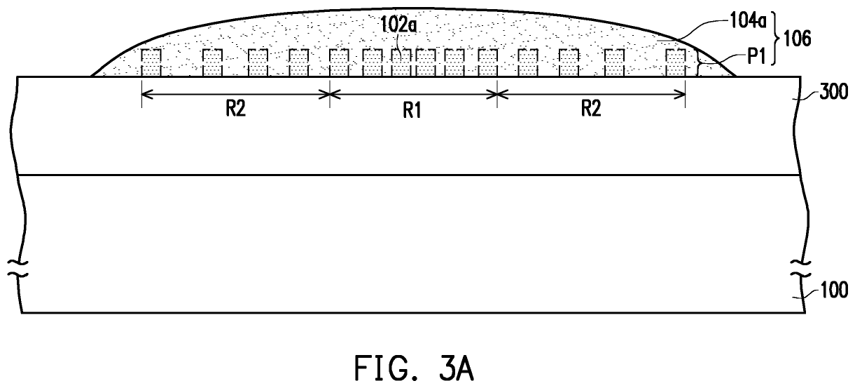

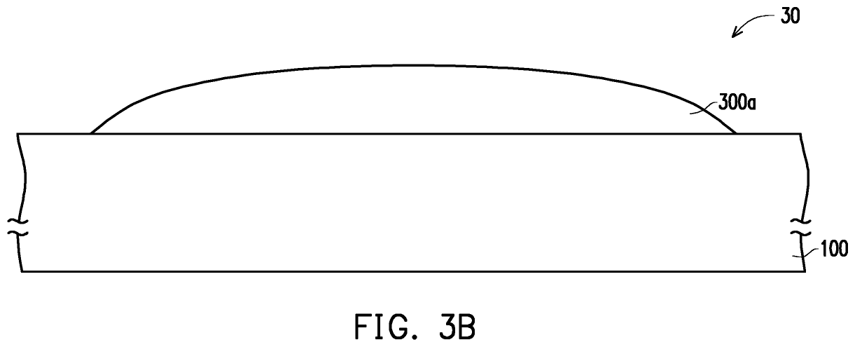

FIG. 3A to FIG. 3B are cross-sectional views of a manufacturing process for a micro-lens structure according to another embodiment of the disclosure.

The differences between FIG. 3A and FIG. 1D in the structure and the manufacturing method are as follows. With reference to FIG. 3A, before the shape adjustment portion P1 is formed, a light transmission layer 300 is formed on the substrate 100. As such, the shape adjustment patterns 102a and the lens pattern 104a subsequently formed may be located on the light transmission layer 300. A material of the light transmission layer 300 is, for instance, silicon oxide, silicon nitride, silicon oxynitride, metal oxide, or an organic light transmission material. A method for forming the light transmission layer 300 is, for instance, chemical vapor deposition, spin coating, physical vapor deposition, and so on. Note that the same components in FIG. 3A and FIG. 1D are denoted by the same reference numbers and thus will not be further described hereinafter.

With reference to FIG. 3B, the light transmission layer 300 is patterned with use of the shape adjustment patterns 102a and the lens pattern 104a as a mask (i.e., the micro-lens 106 is used as the mask), and a pattern composed of the shape adjustment patterns 102a and the lens pattern 104a is transferred to the light transmission layer 300. Thereby, a micro-lens 300a may be formed on the substrate 100, and the micro-lens 300a may be of a symmetrical shape similar to the shape of the micro-lens 106. For instance, in the above patterning process, a dry etching process may be performed on the light transmission layer 300 with use of the shape adjustment patterns 102a and the lens pattern 104a as a mask to remove a portion of the light transmission layer 300 and form the micro-lens 300a on the substrate 100. In addition, the shape adjustment patterns 102a and the lens pattern 104a acting as the mask may be gradually consumed and removed during the patterning process. In another aspect, the height and the width of the micro-lens 300a may also vary according to different etching speed of the shape adjustment patterns 102a, the lens pattern 104a, and the light transmission layer 300. That is, the shape of the micro-lens 300a may be adjusted by setting etching parameters or determining the material of the shape adjustment patterns 102a, the lens pattern 104a, and the light transmission layer 300. Thereby, in other embodiments, the micro-lens 300a and the micro-lens 106 may be of different shapes.

In some embodiments, given that a plurality of micro-lenses 300a are formed by performing the aforesaid method, the adjacent micro-lenses 300a may be separated or merged by adjusting etching conditions.

In this embodiment, although the micro-lens 106 exemplarily serves as a mask for explanation, the disclosure is not limited thereto. In other embodiments, the micro-lens 206 depicted in FIG. 2 may also serve as a mask, so that the micro-lens 300a may be of an asymmetrical shape similar to the shape of the micro-lens 206.

Based on the above embodiment, it can be known that in the micro-lens structure 30 and the manufacturing method therefor, the pattern of the micro-lens 106 as the mask may have the large height; accordingly, the micro-lens 300a formed by transferring the pattern of the micro-lens 106 to the light transmission layer 300 may also have the large height.

To sum up, in the micro-lens structure and the manufacturing method therefor as provided in one or more embodiments of the disclosure, the lens pattern covers the shape adjustment patterns; accordingly, the shape and the height of the lens pattern may be adjusted by arranging the shape adjustment patterns, whereby the micro-lens with the large height may be formed.

Although the disclosure has been described with reference to the above embodiments, it will be apparent to one of ordinary skill in the art that modifications to the described embodiments may be made without departing from the spirit of the disclosure. Accordingly, the scope provided in the disclosure is defined by the attached claims not by the above detailed descriptions.

What is claimed is:

1. A micro-lens structure, comprising:
a substrate; and
a micro-lens, comprising:
a shape adjustment portion, comprising a plurality of shape adjustment patterns on the substrate; and
a lens pattern, covering the shape adjustment patterns.

2. The micro-lens structure according to claim 1, wherein the shape adjustment patterns have various intervals.

3. The micro-lens structure according to claim 1, wherein the shape adjustment portion has a dense pattern region and an isolated pattern region, and intervals of the shape adjustment patterns in the dense pattern region are smaller than intervals of the shape adjustment patterns in the isolated pattern region.

4. The micro-lens structure according to claim 3, wherein a height of the lens pattern in the dense pattern region is greater than a height of the lens pattern in the isolated pattern region.

5. The micro-lens structure according to claim 1, wherein the shape adjustment patterns and the lens pattern have an identical refractive index.

6. The micro-lens structure according to claim 1, wherein the shape adjustment patterns and the lens pattern have different refractive indices.

7. The micro-lens structure according to claim 1, wherein the shape adjustment patterns and the lens pattern are made of an identical material.

8. The micro-lens structure according to claim 1, wherein the shape adjustment patterns and the lens pattern are made of different materials.

9. The micro-lens structure according to claim 1, wherein a material of the shape adjustment patterns comprises a positive photoresist material or a negative photoresist material.

10. The micro-lens structure according to claim 1, wherein a material of the lens pattern comprises a positive photoresist material or a negative photoresist material.

11. The micro-lens structure according to claim 1, wherein the micro-lens is of a symmetrical shape.

12. The micro-lens structure according to claim 1, wherein the micro-lens is of an asymmetrical shape.

13. A method for manufacturing a micro-lens structure, the method comprising:
forming a shape adjustment portion on a substrate, wherein the shape adjustment portion comprises a plurality of shape adjustment patterns; and
forming a lens pattern covering the shape adjustment patterns.

14. The method for manufacturing the micro-lens structure according to claim 13, wherein a method for forming the shape adjustment patterns comprises:
forming a photoresist material layer on the substrate;
performing an exposure process on the photoresist material layer; and
after performing the exposure process on the photoresist material layer, performing a development process on the photoresist material layer.

15. The method for manufacturing the micro-lens structure according to claim 13, further comprising performing curing treatment on the shape adjustment patterns.

16. The method for manufacturing the micro-lens structure according to claim 13, wherein a method for forming the lens pattern comprises:
forming a photoresist material layer covering the shape adjustment patterns;
performing an exposure process on the photoresist material layer; and
after performing the exposure process on the photoresist material layer, performing a development process on the photoresist material layer.

17. The method for manufacturing the micro-lens structure according to claim 13, further comprising performing curing treatment on the lens pattern.

18. The method for manufacturing the micro-lens structure according to claim 13, further comprising:
before forming the shape adjustment portion, forming a light transmission layer on the substrate, wherein the shape adjustment patterns and the lens pattern are located on the light transmission layer; and
patterning the light transmission layer with use of the shape adjustment patterns and the lens pattern as a mask, and transferring a pattern composed of the shape adjustment patterns and the lens pattern to the light transmission layer.

19. The method for manufacturing the micro-lens structure according to claim 18, wherein a material of the light transmission layer comprises silicon oxide, silicon nitride, silicon oxynitride, metal oxide, or an organic light transmission material.

20. The method for manufacturing the micro-lens structure according to claim 18, wherein the shape adjustment patterns and the lens pattern as the mask are gradually consumed and removed during the patterning process.
